(19) United States
(12) Patent Application Publication
(10) Pub. No.: US 2025/0104477 A1
(43) Pub. Date: Mar. 27, 2025

(54) Apparatus and Methods for Gesture Detection

(71) Applicant: CANON U.S.A., INC., Melville, NY (US)

(72) Inventor: Hung Khei Huang, Irvine, CA (US)

(21) Appl. No.: 18/897,658

(22) Filed: Sep. 26, 2024

Related U.S. Application Data
(60) Provisional application No. 63/585,807, filed on Sep. 27, 2023.

(51) Int. Cl. G06V 40/20; G06V 10/22; G06V 20/40; G06V 40/16

(52) U.S. Cl. CPC G06V 40/28; G06V 10/22; G06V 20/41; G06V 40/166

(57) ABSTRACT

An apparatus that communicates with an image capture apparatus configured to capture video data is provided. The apparatus includes one or more memories storing instructions and one or more processors that, upon execution of the instructions stored in the one or more memories, are configured to receive video data from the image capture apparatus, identify at least one subject in the received video data that is in a predetermined pose, identify a first position on the subject identified as being in the predetermined pose, generate a pose region surrounding the identified subject having the identified first position, generate a search region that includes a portion of the identified subject proximate to the first position, search within the search region for a gesture being performed by the one or more subjects, and execute a processing operation corresponding to the detected gesture.

### CROSS REFERENCE TO RELATED APPLICATIONS

This application is nonprovisional patent application that claims the benefit of priority from U.S. Provisional Patent Application Ser. No. 63/585,807 filed on Sep. 27, 2023, the entirety of which is incorporated herein by reference.

### BACKGROUND

### Technical Field

The present disclosure relates to image processing and, more specifically, to detection of gestures performed in captured images.

### Description of the Related Art

It has been desirable to use non-contact input sources to perform control tasks for various computing systems including laptops, smartphones and the like. To achieve this objective, devices having an image capture apparatus are able to capture images and identify body parts of users in the captured image. When attempting to detect a hand gesture in a captured image, the reliability with which these gestures are identified from the image being captured is less than desirable and often yield incorrect false positive and false negative indications of the gesture being detected.

### SUMMARY

A system, a method, and an apparatus according to the present disclosure remedies the drawbacks associated with gesture detection processing to improve accurate detection of gestures being made by a user while minimizing the computation processing time. As a result, there is a minimizing of false positives when determining whether individuals in a captured video frame(s) are intending to make a gesture that is required in order to cause a further processing operation to be performed.

According to the present disclosure, an apparatus that communicates with an image capture apparatus configured to capture video data is provided. The apparatus includes one or more memories storing instructions and one or more processors that, upon execution of the instructions stored in the one or more memories, are configured to receive video data from the image capture apparatus, identify at least one subject in the received video data that is in a predetermined pose, identify a first position on the subject identified as being in the predetermined pose, generate a pose region surrounding the identified subject having the identified first position, generate a search region that includes a portion of the identified subject proximate to the first position, search within the search region for a gesture being performed by the one or more subjects, and execute a processing operation corresponding to the detected gesture.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates a system architecture according to an exemplary embodiment.

FIG. 2 illustrates a hardware architecture according to an exemplary embodiment.

FIG. 3 is a flow diagram illustrating a gesture detection and control algorithm according to an exemplary embodiment.

FIG. 4 is a flow diagram illustrating a gesture detection and control algorithm according to an exemplary embodiment.

FIG. 5 illustrates an expanded pose detection region in an image frame according to an exemplary embodiment.

FIG. 6 illustrates an expanded pose detection region in an image frame according to an exemplary embodiment.

FIGS. 7A & 7B are flow diagrams illustrating a gesture detection and control algorithm according to an exemplary embodiment.

FIG. 8 illustrates a result of the gesture detection and control algorithm according to an exemplary embodiment.

FIGS. 9A & 9B illustrates a result of the gesture detection and control algorithm according to an exemplary embodiment.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Exemplary embodiments of the present disclosure will be described in detail below with reference to the accompanying drawings. The following exemplary embodiments are merely examples for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

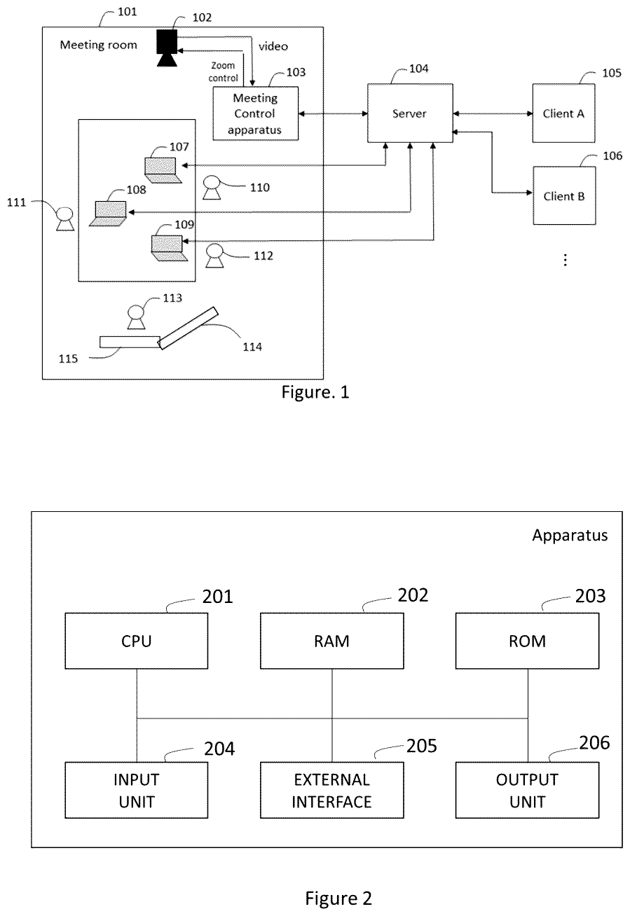

FIG. 1 illustrates a system architecture according to an exemplary embodiment. The system includes an image capture apparatus 102, a meeting control apparatus 103, a server 104, a client computer A 105, a client computer B 106 and communication apparatuses 107-109. The communication apparatuses 107-109 can be a laptop computer, a tablet computer, a smartphone or other type of computing devices and are operated by respective attendees 110-112.

As illustrated in FIG. 1, the client computer A 105 and the client computer B 106 connect to an online meeting held in the meeting room 101 via communication network such as the internet or other local or wide area network. In the present embodiment, the image capture apparatus 102, the meeting control apparatus 103, the communication apparatuses 107-109, the attendees 110-112, a presenter 113 and writing surfaces (e.g. whiteboards) 114-115 are present in the meeting room 101 where an online meeting will be originated and which will includes users of client computer A 105 and client computer B 106. This is but one exemplary type of meeting situation and should not be seen as limiting. In another exemplary embodiment, for example, the functionality provided by the meeting control apparatus 103 as described below can be located in the cloud.

The meeting control apparatus 103 includes all the local modules required to facilitate an online meeting between users in the meeting room 101 and remote users. The modules include, but are not limited to, a gesture recognition module, image capturing apparatus control module (pan/tilt/zoom), and meeting state management module. The server 104 manages meeting resources, and communication/synchronization between clients and modules included in the meeting control apparatus 103.

The image capture apparatus 102 captures video in the meeting room 101 while a meeting is in progress. The image capture apparatus 102 captures gestures by the attendees 110-112 and the presenter 113. The captured video is transmitted to the meeting control apparatus 103. As described above, the meeting control apparatus 103 can recognize user's gesture included in the video, and execute the process corresponding to the gesture. The details will be described below.

Once the online meeting is started by a user present in the meeting 101, the client computer A 105 and the client computer B 106 can be provided a link which enables those devices to access the meeting which has begin and display the video captured by the image capture apparatus 102 within a user interface on their respective devices 105/106 so that remote attendees can view what is going on in the meeting room 101. The image capture apparatus 102 is positioned to capture a single, wide view of the meeting room 101 such that all participants and any writing surface present in the meeting room can be captured and provided to the remote participants. This, for example, includes, anything that may be written on the white boards 114-115. The communication apparatuses 107-109 can display the same video so that attendees 110-112 are able to view what the remote attendees are viewing. Additional operations performed by the meeting control apparatus 103 in combination with the image capture apparatus 102 which further improve the view that remote participants are provided will be discussed hereinbelow.

FIG. 2 illustrates a hardware architecture according to an exemplary embodiment that represents the hardware architecture of the image capture apparatus 102, the meeting control apparatus 103, the server 104 and the communication apparatuses 107-109. The hardware architecture includes a CPU 201, a RAM 202, a ROM 203, an input unit 204, an external interface 205, and an output unit 206. For description purposes, the meeting control apparatus 103 will be referred to/used to describe the various components illustrated in FIG. 2.

The CPU 201 controls the meeting control apparatus 103 via a computer program (one or more series of stored instructions executable by the CPU 201) and data stored in the RAM 202 or ROM 203. The meeting control apparatus 103 can include one or more dedicated hardware or a graphics processing unit (GPU), which is different from the CPU 201, and the GPU or the dedicated hardware can perform a part of the processes by the CPU 201. As an example of the dedicated hardware, there are an application specific integrated circuit (ASIC), a field-programmable gate array (FPGA), and a digital signal processor (DSP), and the like.

The RAM 202 temporarily stores the computer program or data read from the ROM 203, data supplied external from the meeting control apparatus 103 via the external interface 205, and the like. The ROM 203 stores the computer program and data that do not need to be modified and that can control the basic operation of the meeting control apparatus 103.

The input unit 204 is composed of, for example, a joystick, a jog dial, a touch panel, a keyboard, a mouse, or the like, receives a user operation, and inputs various instructions to the CPU 201. The external interface 205 communicates with external device such as PC, smartphone, camera and the like. The communication with the external devices can be performed via a wired interface such as a local area network (LAN) cable, a serial digital interface (SDI) cable or can performed wirelessly via a wireless interface such as Wi-Fi®, etc., The output unit 206 is composed of, for example, a display unit and a sound output unit such as a speaker, and displays a graphical user interface (GUI) and outputs a guiding sound so that the user can operate the meeting control apparatus 103 as needed.

In exemplary operation, the online meeting initiated by the meeting control apparatus 103 and facilitated by server 104 advantageously enables remote participants to view the specific goings on of in the meeting room. This includes, for example, viewing images of the in-room participants and any writing they perform on the writing surfaces or anything displayed on a display surface such as a table thereby enabling effective communication in a hybrid work environment. This is achieved by the meeting control apparatus 103 executing one or more predetermined processing operations. In exemplary embodiments, the one or more predetermined processing operations are responsive to user behavior and/or movement that is captured by the image capture apparatus 102 and processed by one or more of the control modules executing on the meeting control apparatus 103. In one embodiment, the user behavior is a gesture being performed by a user present in the meeting room. More specifically, detecting that a particular hand gesture has been made in a video data stream captured by the image capture apparatus 102. For example, at least four different processing operations can be performed in response to detecting a position and orientation of a user's hand in the captured video date. The position and orientation of a hand of a user is a hand sign or hand gesture. These four different processing operations include: “Start meeting”, “End meeting”, “Capture white board”, and “Spotlight”. “Start meeting” refers to starting an online meeting. “End meeting” refers to ending the online meeting. “Capture white board” refers to capturing an image of white boards 114, 115 by the image capture apparatus 102. “Spotlight” refers to capturing an image of a location where a user places the user's hand. “Start meeting” can, for example, correspond to a “thumbs up” gesture, “end meeting” corresponds to a user holding their palm of their hand facing the image capture apparatus with the fingers in a vertical position, “capture whiteboard” corresponds to a user's hand being in the orientation of the letter “C”, and “Spotlight” can correspond to a gesture where a user opens and closes their fingers with the palm of the user's hand facing the image capture apparatus 102.

The “spotlight” operation may result in a number of false positive or negative detections because of the nature of the hand gesture required and the normal human movements that may occur during the meeting. Therefore, ensuring that the “spotlight” operation is intended at a given time is important so that the in-person participants can share the desired information with all remote participants. The following describes an improved manner to determining that a gesture detected in a video data stream captured by the image capture apparatus 102 is actually intended to be performed. In the case of “Spotlight”, an image captured at the location where a hand gesture is performed occurs after the hand is removed from the vicinity of the location. More specifically, the image data corresponding to the “Spotlight” is extracted from the captured video data by the meeting control apparatus 103. The meeting control apparatus 103 then communicates with the server 104 via communication network to transmit the image data to the client computers A105 and B106. Each of the client computers A105 and B106 display the image data concurrently with at least a wide angle view, which was captured by the image capture apparatus 102, of the room where the “Spotlight” occurred.

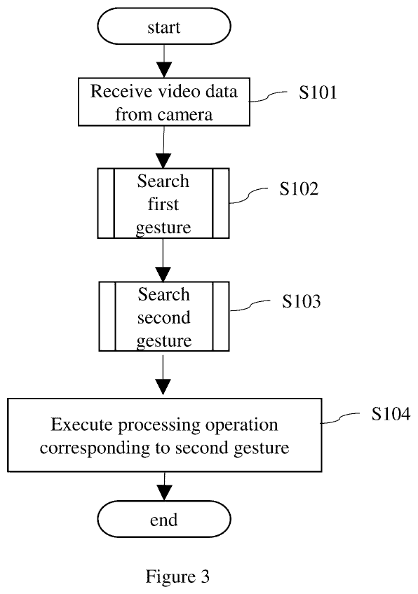

FIG. 3 illustrates a flowchart for gesture recognition according to an exemplary embodiment. The processing of the flowchart is performed by CPU 201 of the meeting control apparatus 103 executing a program stored in RAM 202 or ROM 203 of the meeting control apparatus 103. The process enables reducing the number of false positives (or negatives) of gesture recognition, where the user performs a first gesture, such as raising the user's hand, to enable a sign detection period during which a second gesture such as making a predetermined hand sign is added.

In S101, the CPU 201 of the meeting control apparatus 103 receives the video data from the image capture apparatus 102. In S102, the CPU 201 searches for a particular first gesture in the acquired video data. In one exemplary embodiment, the first gesture represents a user gesture, such as a user moving a particular body part into a predetermined position like raising an arm and hand, such that the hand is positioned over the user's head and/or face performing the first gesture. In an exemplary embodiment, the first gesture includes a part of the user's body that is also used to make the second gesture as described below. In an exemplary embodiment, the first gesture is a hand raising gesture and the second gesture is performed by the same raised hand. The location in the video frame where the second gesture is to be performed by the hand is different from the location where the hand was located when the first gesture was detected. As described below, the first gesture is a user gesture. In another embodiment, the second gesture may be performed by a hand of the user on the arm opposite of the one making the first gesture.

In an exemplary embodiment, the CPU 201 searches an entire image frame for a hand raising gesture. In one exemplary embodiment, execution of a stored gesture detection library that includes processing operations that identifies skeletal architecture of a human subject such that respective positions of the human body is recognized to generate a frame corresponding to the user (human) in the captured image frame. Execution of the library on each image frame results in the identification of one or more objects or individuals in the captured image frame to determine whether the one or more individuals are making a predetermined pose such as raising of their hand by extending an arm above a head line of the individual. If the CPU 201 detects a hand raising gesture, an area surrounding the individual making the hand raise gesture (or hand raise pose being detected) is determined and searched to see if a second gesture is being performed by that same individual thereby triggering a particular system operation. In S103, the CPU 201 searches the image frame for the hand gesture a defined search area. This searching occurs over a predetermined search duration. If the CPU 201 finds the hand gesture and recognizes the type of hand gesture, the CPU 201 executes a process corresponding to the hand gesture (“Start”, “End”, “Capture”, “Spotlight”) in S104. The details of S102 and S103 are described below.

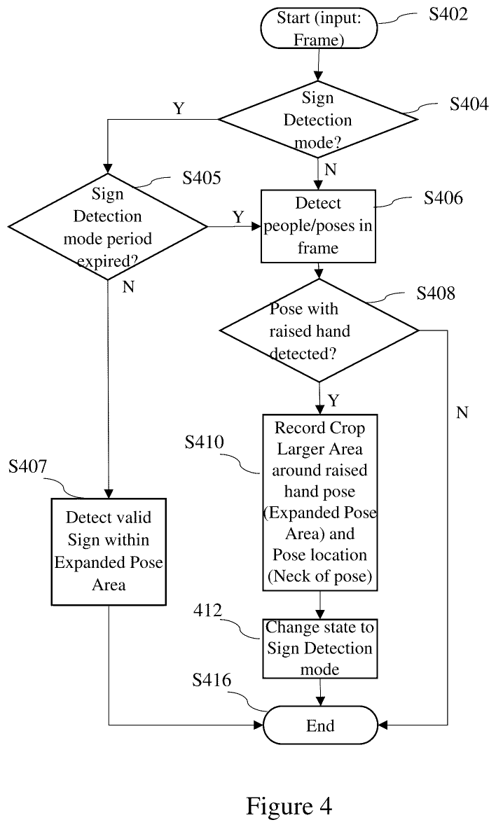

FIG. 4 illustrates a flowchart of the processes performed in S102 in FIG. 3 for detecting a hand raising gesture and triggering the second detection processing mode described hereinafter with respect to S103 in FIG. 3. This flowchart is performed by the CPU 201 of the meeting control apparatus 103 executing a program (e.g. a set of computer executable instructions) stored in RAM 202 or ROM 203 of the meeting control apparatus 103. In step S402, processing on the received video data stream is performed to identify one or more individuals performing the first gesture whereby a particular pose is detected in a particular image frame being processing by the system. It should be understood that the processing described herein is performed on frame by frame basis in real time.

As shown herein, an image frame captured by the image capture device 102 as described above is provided, to the meeting control apparatus 103, as an input image frame for processing to determine whether the input image frame contains one or more individuals and to determine whether the detected one or more individuals in the input image frame are performing a first gesture. In one embodiment, performing the first gesture includes at least detecting that respective one or more of the individuals in the captured image frame(s) are being in (or in the process of moving into) a predetermined pose within the input image frame. In one example, the predetermined pose is an individual being positioned such that their arm and/or hand is determined to be positioned above their head. This detection and determination may be performed, for example, using a pose detection library such as OpenPose or Media Pipe. It should also be understood that, within a single input image frame more than one individual present in the image frame may be detected as performing or being in the predetermined pose. In this instance, a respective one of the detected individuals is selected and further processing to determine if that individual is performing the second gesture, as described hereinafter, is performed. In a case where it is determined that more than one individual is in the predetermined pose and a first individual is selected, a region of the image frame that includes other individuals in the predetermined pose is stored and further processing is performed on those regions either simultaneously (in parallel with the first individual) or subsequently after the further processing on the first individual has been completed. This may be determined based on the processing power of the computing device performing this processing and may be adjusted, in real-time, depending on current processing parameters and usage.

Thereafter, in S404, a determination is made whether the system is in a sign detection mode. If the determination in S404 indicates that system is in the sign detection mode, a further determination is made in S405 to determine whether a detection time period has elapsed. The detection time period is a time period a predetermined duration of time set (or otherwise configured) such that the algorithm determines if the second gesture is being performed (S103 in FIG. 3). If the time period has not elapsed then sign detection processing is performed in S407. If the time period has elapsed the algorithm executes the routine associated with S102 in FIG. 3. The routine of S102 in FIG. 3 includes performing pose detection, in S406, to determine whether one or more individuals are in the predetermined pose within the image frame as. In S408, a determination regarding the individuals detected in the image frame and whether, if individuals are detected, whether those individuals are performing the first gesture (or predetermined pose). In exemplary operation, the detection processing and determination performed in S406/S408 includes detecting whether any individuals in the input image frame are in a predetermined pose whereby at least a hand of the detected individual is determined to be positioned above the head of the individual. If no individuals are determined as making the predetermined pose in S408, the processing ends at S416. Upon ending a single instance of detection processing for the given input image frame, processing does revert back to S402 to begin the processing on a next image frame in a series of image frames.

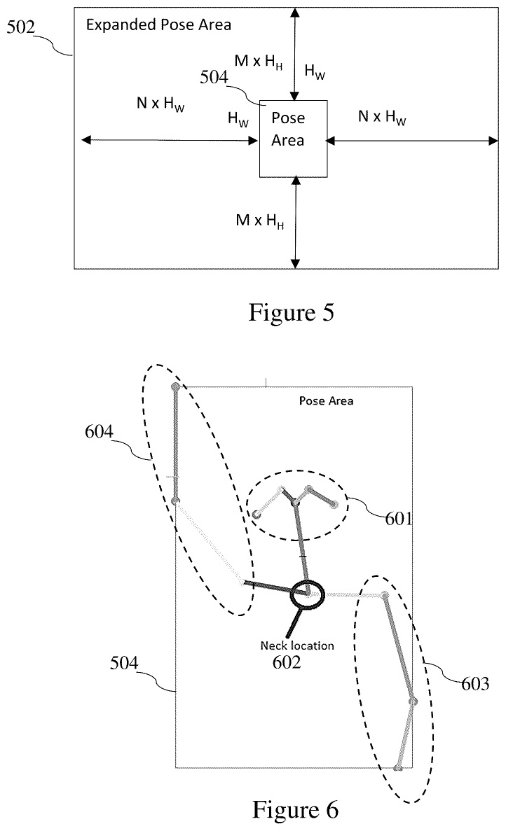

In a case where the determination in S408 indicates that an individual is positioned in the predetermined pose (hand raise) is detected, image parameters for the particular input image frame are generated and stored in memory. The generated image parameters will be discussed in reference to FIGS. 5 and 6. A first image parameter is generated to set an expanded pose area. The set expanded pose area includes a region represented by the rectangle 502 in FIG. 5. The expanded pose area comprises rectangle 502 having dimensions of a predetermined number of pixels in a width direction (w) and predetermined number of pixels in a height direction (h) and which includes, a substantially a center point thereof (602 in FIG. 6), a second parameter that corresponds to a predetermined anatomical feature (x,y). In one embodiment, the predetermined anatomical feature corresponds to a neck location of a user as output by the pose detection library analysis of the input image frame. A third image parameter is set (or obtained from memory) and represents a configurable expansion parameter that is used to expand the pose area to define a search region for searching for performing of the second gesture as will be discussed below. The third image parameter includes a height expansion value M and a width expansion value N. In one embodiment, the expansion parameters are set to N=3 and M=0.4 which is applied to the pixel value in each of the width value and height value, respectively.

These parameters are used to generate an Expanded Pose Area 502 and Neck Location 602 of the individual which are then used to detect valid sign in subsequent frames. In FIG. 6, applying the pose detection library to the input image frame results in output shown in FIG. 6 which identifies the skeletal structure of the detected individual. FIG. 6 illustrates the pose are region 504 from FIG. 5. Applying the pose detection library to the pixels in pose area region 504 results in the output of the skeletal structure in FIG. 6. As shown in FIG. 6, the pose detection library detects a head region shown in the dotted circle labeled 601 and first arm area 603 and second arm 604. Based on the identification of the head region 601 and arm regions 603 and 604, the predetermined anatomical region 602 corresponding to the neck region of the individual can be identified and a pixel location values (x,y) can be obtained and set as the second parameter. Further, based on the output of the skeletal structure a bounding box representing the first parameter which includes a height and width in pixels which surrounds the head, neck and arms of the individual is determined. The third image parameter (expansion parameter) is applied using the second image parameter as the substantial center point and the third parameter for expansion is applied to the first parameter (pose area) to generate at least one bounding box representing an expanded pose area 502 in FIG. 5. Once the expanded pose area is generated as described below, the system is caused to switch to sign detection mode and search the expanded pose area to determine if the second gesture is being performed.

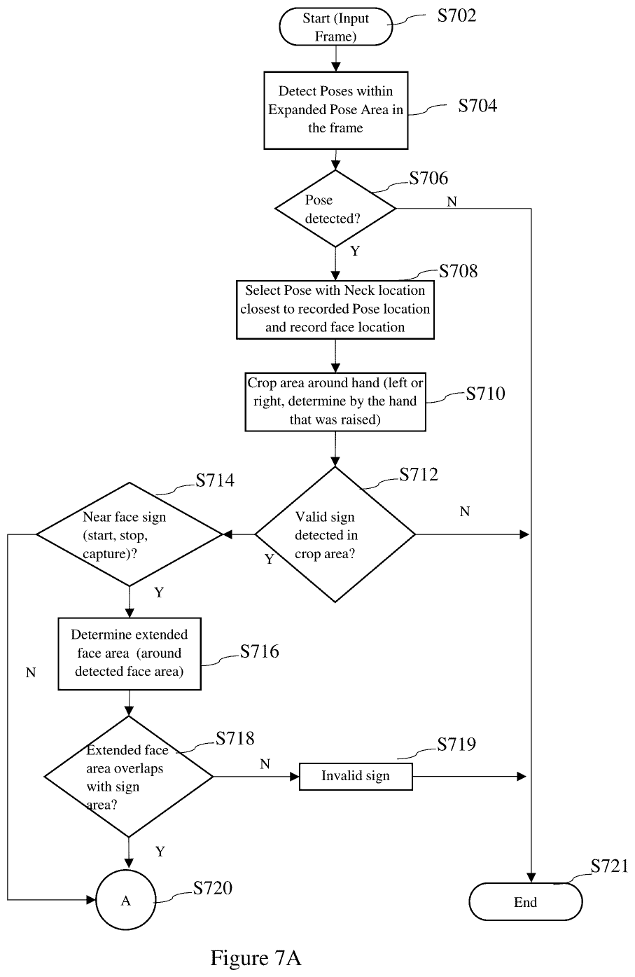

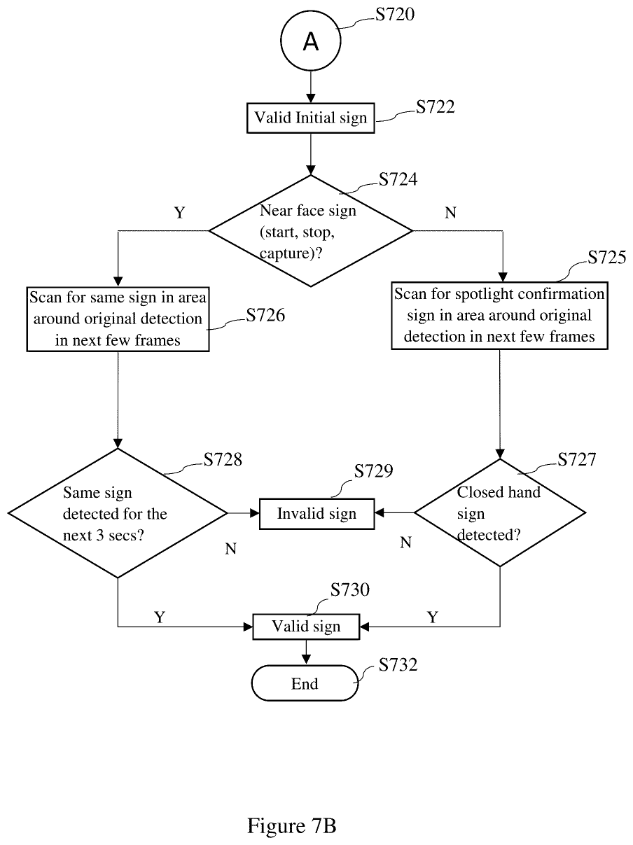

Turning now to FIGS. 7A & 7B which illustrates the processing steps required to perform hand sign detection (e.g. second gesture detection) processing in S103. The flowchart is performed by the CPU 201 of the meeting control apparatus 103 executing a program stored in RAM 202 or ROM 203 of the meeting control apparatus 103. The flow includes the following processing steps.

The algorithm described in FIGS. 7A & 7B is applied to every image frame which is processed as discussed above with respect to FIGS. 5 and 6 to obtain and use image parameters to generate the expanded pose area corresponding to the rectangle 502 (x,y,w,h) in FIG. 5 within the image frame based on the raised hand pose area and a neck location 602 (x,y) of the neck for the raised hand pose. Processing begins at S702 by receiving or otherwise obtaining from an image capture device 102, an input image frame. In one embodiment, the input image frame is obtained in real time as it is being captured. In other embodiments, captured images are stored and the algorithm described herein is applied in near real time. In step S704, pose detection processing as discussed above is performed on the input image frame to detect one or more individuals and whether the detected individuals are making or positioned in the predetermined pose (e.g. hand raise). In step S706, a determination is made as to whether the one or more individuals detected by the pose detection processing are making or performing the predetermined pose. If the result of the determination in S706 is negative indicating that the predetermined pose is not detected (NO in S706), processing ends at S721 and the algorithms described herein are restarted for subsequent image frames captured by the image capture device 102 and then input at a later time. If the result of the determination in S706 indicates that the predetermined pose is detected in the image frame (YES in S706), a further determination is made to determine which of the detected pose should be identified as the selected pose upon which sign detection is performed. This is particularly advantageous in a case where the input image frame includes a plurality of individuals in different positions that may be the predetermined pose or which might appear to be the predetermined pose and thus a determination as to which of the plurality of poses is the actual pose to be used. In this manner, in a case where multiple poses are detected, the target pose is the pose that is closest to the predetermined anatomical position (602 in FIG. 6). For example, the algorithm detects the neck position of the individual and compares the distances between the detected pose (i.e. hand raised indicated by 604 in FIG. 6) and the neck and identifies, as the target pose for further processing, the pose that has the smallest distance between the neck and the raised hand using Equation 1.

$$AB = \sqrt{{( {x}_{2} - {x}_{1} )}^{2} + {( {y}_{2} - {y}_{1} )}^{2}} \qquad ( 1 )$$

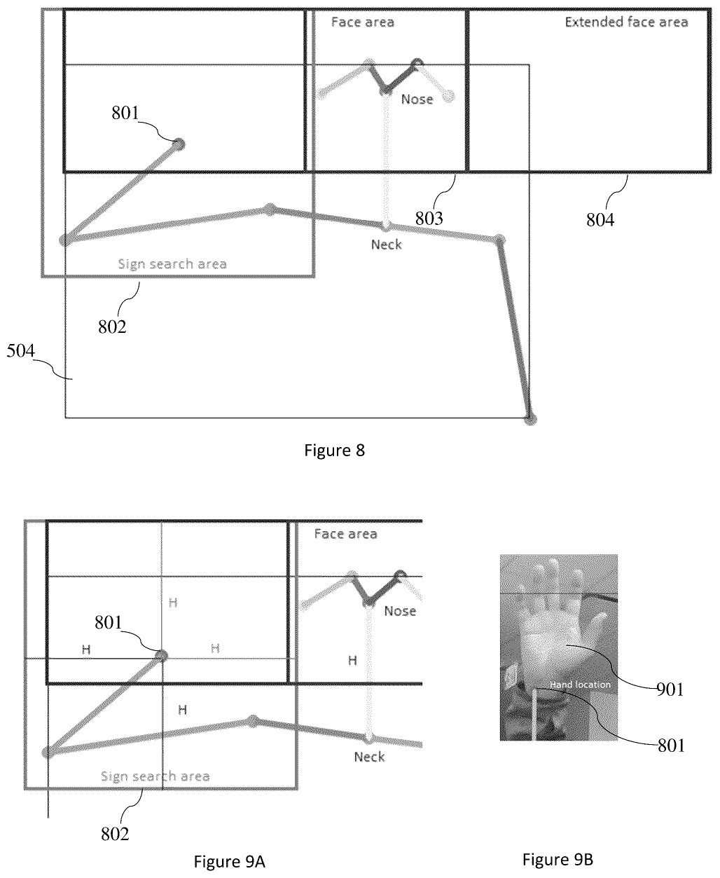

Based on the determination in S706, in step S708 a pose detected/selected based on the determination of the position of the pose (e.g. arm/hand raised) relative to the predetermined anatomical feature (neck position) such that location information associated with each of the pose, anatomical location and a face of the individual are recorded in memory. Using the recorded location information, the algorithm switches from pose detection to sign detection processing. In so doing, a sign search area is determined in S710. In S710, the sign search area represents a region in the image frame that is further analyzed to determine whether the individual is positioning or making a predetermined sign (e.g. second gesture) using their hand. In S710, the hand (left or right) that was raised and which satisfied the condition of the predetermined pose being made is used to determine which hand will be used to create search area. The sign search area (W×H) is computed as N times the vertical distance between the nose and the neck (N is configurable. Currently N=2). The generated sign search area bounding box 802 is shown in FIG. 8. The sign search area bounding box 802 is shown positioned over the pose area bounding box 504 (as described in FIGS. 5 and 6). The computation which generates the sign search area bounding box 802 includes a hand 801 of a individual, as detected using the pose detection library, as a substantial center point. In exemplary operation, the manner in which the sign search area 802 is generated will be discussed with respect to FIGS. 9A & 9B. FIG. 9A illustrates an expanded view of FIG. 8 that illustrates pose hand location 801 and FIG. 9B is a cropped section of the input image frame that was captured by the image capture device 102 that depicts an actual hand of the individual who is making the pose in the input image frame. FIG. 9A illustrates the result of the pose detection library processing on the input image frame and illustrates the pose hand location 801 being the joint between the hand and the arm. For reference, this same point 801 is shown in shown in FIG. 9B in the input image that depicts the hand 901 of the user. To generate the sign search area bounding box, the algorithm uses the output of the pose detection library to identify a distance H (in FIG. 9) between the predetermined anatomical feature and a second anatomical feature of the detected individual. In exemplary operation, the generation of the sign search area bounding box 802 identifies distance H as being a value equal to the vertical distance between nose and neck and applying an predetermined expansion factor to the identified distance H wherein the expansion factor is a preset number resulting in the Sign Search Area Width equaling 2*H and Sign Search Area Height equaling 2*H. The expansion factor being set at 2 is illustrated for exemplary purposes only and the number is configurable.

After the sign search area 802 is defined, a determination is made in S712 to determine if a valid sign is being made. The determination of a valid sign includers whether the hand (901 in FIG. 9B) in the search area 802 is positioned or in an arrangement that corresponds to one of the predetermined signs described herein that, if detected, would cause further processing to be performed. The pose detection library is used to identify the position of the fingers on the hand and compares them to stored hand position information that corresponds to one of the predetermined signs (i.e. second gestures). If the result of the determination in S712 indicates there is no valid being made by the individual in the sign search area 802, processing on the input image frame ends in step S721. If the determination in S712 indicates that a valid sign is detected in Sign search area 802, a further determination is made in S714 as to whether the valid sign includes a position requirement in order for the sign to be indicated as causing a further processing action to be performed. In one embodiment, the determination in S714 determines whether the position of the hand in sign search area 802 is a sign that, in order for it to be used to control further processing, is positioned within a predetermined distance from a face of the user. If the determination in S714 is negative (NO in S714), the algorithm proceeds to S720 and the algorithmic processing continues in FIG. 7B as will be discussed hereinbelow. If the result of the determination in S714 indicates that the sign detected in the sign search area 802 does have a positional requirement (YES in S714), a positional bounding box 804 in FIG. 8 is generated in S716 to determine if the sign is in fact a valid sign. In the exemplary embodiment, the positional requirement indicates that, for the sign to be valid and control further processing, the detected sign needs to be within a certain distance from a face of the user. Thus, in S716, a face bounding box (803 in FIG. 8) is generated based on the output of the pose detection library which surrounds a face of the user. As shown in FIGS. 8 and 9A, the face of the user is determined using the skeletal joints extending from a nose and eyes of the face. Further, the positional bounding box 804, illustrated in FIGS. 8 and 9A, is an extended face region bounding box which is computed by applying a predetermined horizontal expansion factor to a width of the face bounding box 803. Moreover, the generated positional bounding box 804 extends on both sides of the face bounding box 803 in order to ensure that left and right handed signs that might be made, are properly accounted for and evaluated. In one embodiment, the computed extended face area uses a horizontal margin expansion factor of 1.5 times the face width with no vertical margin expansion factor being added. These is merely described for purpose of example only and the value of the expansion factor is configurable as is the ability to generate the positional bounding box 804 using a vertical expansion factor.

After generating the positional bounding box 804 on each side of the face bounding box 803, a determination in S718 is made to determine if the generated positional bounding box 804 overlaps the generated sign search area bounding box 802. If the sign includes a positional requirement and it is determined that there is overlap between bounding boxes 802 and 804, then the detected sign is considered valid (YES in S718) and processing proceeds to S720 which continues the algorithm in FIG. 7B. If the bounding boxes 802 and 804 do not overlap (No in S718) it is determined that any hand position that might be considered a sign is invalid in S719 causing this processing on the respective input image frame to end at S721.

Turning now to FIG. 7B, processing continues to determine which, if any, further processing operations are to be performed after detection of a valid initial gesture in the input image frame. More specifically, in step S722, a valid initial sign is determined to be present either after the positive determination in S718 indicating that the search area bounding box (802 in FIG. 8) overlaps with the positional bounding box (804 in FIG. 8) or after a negative determination in step S714 indicating that there is no positional requirement associated with the detected sign in sign search area 802. Upon determining, in S722, that an initial valid gesture is detected a further determination is once again made in S724 whether the initially detected valid gesture is one that is required to be performed proximate to the face of a user. Once a valid sign is detected, processing is performed in step S724 to monitor a crop area (sign search area 802 in FIG. 8) in the same location as the hand with valid sign (M=0.5 and N=0.5) in the subsequent frames as shown in step S726. In a case where the determination is positive (“Capture”, “Stop”, “Start”), scanning in the crop area is performed in S726 for a predetermined number of subsequently captured image frames to determine, in step S728, whether the hand detected in the sign search area 802 is a predetermined hand sign in a position for a predetermined amount of time (e.g. 3 seconds). If the determination is negative (No in S728), the result of the gesture detection processing concludes at step S279 indicating that the sign is invalid and no gesture is detected. If the result of the determination in S728 is positive (YES in S728), then it is determined, in S730, that the hand sign present in the sign search area 802 (crop area) proximate to the face of the user which is facing the camera is a valid sign. The indication of a valid sign triggers the associated processing to be performed.

Returning back to S724, if the determination that the initially valid sign is not required to be near the face of the person (NO in S724), it is determined that the valid initial sign is indicative of a “Spotlight” function. Because the hand sign associated with “spotlight” function requires a user's palm to face the image capture apparatus and open and close the fingers on the hand, scanning is performed, in S725, to determine whether there is a change in hand (and finger) position over subsequent image frames which indicates that this operation is being performed. At the conclusion of the predetermined number of frames in S725, if it is determined that the final frame in the series of image frames, includes a closed hand sign being detected in the sign scan area 802 (YES in S727), the result is marked as a valid sign in S730. If the determination is negative (NO in S727), the result of the gesture detection processing concludes indicating that the sign is invalid in step S729 and no gesture is detected.

In a case where a large group of individuals are in the meeting room 101, the probability of a hand accidently/unintentionally generating a valid sign can be high, which could trigger an unintentional action by the system. The above-described exemplary embodiments provide combining a valid sign with a face facing the image capturing apparatus and distance with the face for certain hand signs, where a hand sign is confirmed if it is a valid sign plus a face nearby is also looking at the image capturing apparatus. This significantly reduces the number of false positives.

The above-described processes differ based on the type of the hand gesture. The “Spotlight” does not require the gesture to be near a face and the face facing the image capturing apparatus since it needs to indicate a location of an area to be spotlighted. The “Capture”, “Stop”, and “Start” are actions not associated with location of an area. The movement of the “Spotlight” (opening and closing fingers with the palm facing the image capture apparatus 102) is unique compared to other types of hand signs. Detection of a “Spotlight” that is not near the face does not lead to false positives.

In other exemplary embodiments, the CPU 201 skip some processes when the “Spotlight” is detected. For example, the CPU 201 can skip the determination process whether the “Spotlight” is detected near the face (N=5 and M=4). In other embodiments, the CPU 201 can skip the determination process whether the face is facing the image capturing apparatus. In a further embodiment, the CPU 201 can skip both determination steps if the false positive rate of the “Spotlight” is low. In other words, the CPU 201 can change the process to validate the hand sign when a certain type of hand sign (“Spotlight”) is detected.

In other exemplary embodiments, the CPU 201 can skip some processes when other hand signs (“Capture”, “Stop”, “Start”) are detected if the false positive rate is low. For example, the CPU 201 can skip the determination process whether the hand signs are detected near the face (N=3 and M=1) and only perform the determination process whether the face is facing the image capturing apparatus. The CPU 201 may further skip the determination process whether the face is facing the image capturing apparatus and only perform the determination process whether the hand signs are detected near the face (N=3 and M=1).

In the above-described embodiments, the CPU 201 searches for a hand raising gesture as a human gesture in S102 in FIG. 3. This is not seen to be limiting. In another exemplary embodiment, the human gesture to trigger the hand sign detection can include other gestures, such as V sign, waiving a hand, etc., After detecting these human gestures, the CPU 201 limits the searching area and the searching time for hand sign detection. This enhances reduction in false positives of hand sign detection.

As discussed, the above-described exemplary embodiments reduce the occurrence of false positives and provide a more focused area of the image frame relative to other areas or the entire image frame in order to search for valid sign in a more targeted area. By adding a hand tracking state valid sign, overall detection is improved, especially when the meeting room 101 includes a large number of individuals.

The occurrence of false positives is reduced by providing a detection mechanism that detects a raised hand pose to limit a time when sign detection processing is to be performed by using the raised hand pose to bound the area in the image frame where sign detection processing is to be performed that focuses on the area of the person to only detect hand signs in the focused area. The focus on the area around where the hand pose is detected prevents a situation where a sign, that is otherwise valid hand sign, made by a person other than the person making the raised hand pose and in another area of the image could be detected. This reduces the chances of unintended processing occurring that could disrupt an online meeting. Including hand tracking provides improvement of the above-described two-stage process and can help ensure that only intended gestures are detected and the processing associated with the intended gestures are performed.

According to the above, execution of the stored instructions configures the controller (or other processor) to perform a control method for controlling an apparatus that communicates with an image capture apparatus configured to capture video data which includes receiving video data from the image capture apparatus; identifying at least one subject in the received video data that is in a predetermined pose; identifying a first position on the subject identified as being in the predetermined pose; generating a pose region surrounding the identified subject having the identified first position; generating a search region that includes a portion of the identified subject proximate to the first position; searching within the search region for a gesture being performed by the one or more subjects; and executing a processing operation corresponding to the detected gesture.

In another embodiment the method further includes identifying, based on the first position, a second position on the subject that is above the first position relative a ground surface, generating a face region surrounding the identified second position, wherein the search region is generated based on the position of the face region and the identified first position in the pose region.

In another embodiment, the method includes identifying, based on the first position, a second position on the subject that is above the first position relative a ground surface, generating a face region having predetermined horizontal and vertical pixel values with the identified second position as a substantial center point thereof, identifying, within the face region, a presence of a predetermined portion of the subject, and generating the search area to include the predetermined portion of the subject identified within the face region.

A further embodiment includes identifying at least one other portion of the subject connected to the predetermined portion and which extends from the first position on the subject, generating the search area to include the predetermined portion of the subject identified within the face region and the at least one other portion of the subject.

While different exemplary embodiments have been described, respective features of each of these exemplary embodiments can be combined in accordance with the principles of the disclosure therein. As such, the above descriptions are intended to clearly describe the principles of each exemplary embodiment and skilled artisans would be able to combine respective features of one or more of the exemplary embodiments and combine them with features of any of the other exemplary embodiments.

The scope of the present disclosure includes a non-transitory computer-readable medium storing instructions that, when executed by one or more processors, cause the one or more processors to perform one or more exemplary embodiments of the present disclosure. Examples of a computer-readable medium include, but are not limited to, a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can be supplied to the computer-readable storage medium via download via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

The present disclosure can be incorporated in the form of a variety of embodiments, only a few of which are disclosed herein. Variations of those embodiments may become apparent to those of ordinary skill in the art upon reading the foregoing description. Accordingly, this disclosure and any embodiments derived therefrom includes all modifications and equivalents of the subject matter recited in the claims appended hereto as permitted by applicable law. Any combination of the above-described elements in all possible variations thereof is encompassed by the disclosure unless otherwise indicated herein or otherwise clearly contradicted by context.

What is claimed is:

1. An apparatus that communicates with an image capture apparatus configured to capture video data, the apparatus comprising:
one or more memories storing instructions;
one or more processors that, upon execution of the instructions stored in the one or more memories, are configured to:
receive video data from the image capture apparatus;
identifying at least one subject in the received video data that is in a predetermined pose;
identify a first position on the subject identified as being in the predetermined pose;
generate a pose region surrounding the identified subject having the identified first position;
generate a search region that includes a portion of the identified subject proximate to the first position;
search within the search region for a gesture being performed by the one or more subjects; and
execute a processing operation corresponding to the detected gesture.

2. The apparatus according to claim 1,
wherein execution of the stored instructions further configure the one or more processors to:
identify, based on the first position, a second position on the subject that is above the first position relative a ground surface;
generate a face region surrounding the identified second position;
wherein the search region is generated based on the position of the face region and the identified first position in the pose region.

3. The apparatus according to claim 1,
wherein, execution of the stored instructions further configure the one or more processors to:
identify, based on the first position, a second position on the subject that is above the first position relative a ground surface;
generate a face region having predetermined horizontal and vertical pixel values with the identified second position as a substantial center point thereof;
identify, within the face region, a presence of a predetermined portion of the subject; and
generate the search area to include the predetermined portion of the subject identified within the face region.

4. The apparatus according to claim 3,
wherein, execution of the stored instructions further configure the one or more processors to:
identify at least one other portion of the subject connected to the predetermined portion and which extends from the first position on the subject;
generate the search area to include the predetermined portion of the subject identified within the face region and the at least one other portion of the subject.

5. The apparatus according to claim 1,
wherein the predetermined pose gesture includes a hand raising action.

6. The apparatus according to claim 1,
wherein the predetermined gesture includes a hand sign.

7. A method for controlling an apparatus that communicates with an image capture apparatus configured to capture video data, the apparatus comprising:
receiving video data from the image capture apparatus;
identifying at least one subject in the received video data that is in a predetermined pose;
identifying a first position on the subject identified as being in the predetermined pose;
generating a pose region surrounding the identified subject having the identified first position;
generating a search region that includes a portion of the identified subject proximate to the first position;
searching within the search region for a gesture being performed by the one or more subjects; and
executing a processing operation corresponding to the detected gesture.

8. The method according to claim 7,
identifying, based on the first position, a second position on the subject that is above the first position relative a ground surface;
generating a face region surrounding the identified second position;
wherein the search region is generated based on the position of the face region and the identified first position in the pose region.

9. The method according to claim 7,
identifying, based on the first position, a second position on the subject that is above the first position relative a ground surface;
generating a face region having predetermined horizontal and vertical pixel values with the identified second position as a substantial center point thereof;
identifying, within the face region, a presence of a predetermined portion of the subject; and
generating the search area to include the predetermined portion of the subject identified within the face region.

10. The method according to claim 9,
identifying at least one other portion of the subject connected to the predetermined portion and which extends from the first position on the subject;
generating the search area to include the predetermined portion of the subject identified within the face region and the at least one other portion of the subject.

11. The method according to claim 7,
wherein the predetermined pose gesture includes a hand raising action.

12. The method according to claim 7,
wherein the predetermined gesture includes a hand sign.
